(19) United States
(12) Patent Application Publication
(10) Pub. No.: US 2010/0010982 A1
(43) Pub. Date: Jan. 14, 2010

(54) WEB CONTENT CHARACTERIZATION BASED ON SEMANTIC FOLKSONOMIES ASSOCIATED WITH USER GENERATED CONTENT

(76) Inventors: Andrei Z. Broder, Menlo Park, CA (US); Evgeniy Gabrilovich, Sunnyvale, CA (US); Bo Pang, Sunnyvale, CA (US); Vanja Josifovski, Los Gatos, CA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(21) Appl. No.: 12/169,761

(22) Filed: Jul. 9, 2008

(51) Int. Cl. G06F 7/06; G06F 17/30

(52) U.S. Cl. 707/5; 707/E17.014

(57) ABSTRACT

The present invention is directed towards a method and system for characterizing web content based on capturing semantics of folksonomies relating to content entities of user generated content. The method and system includes determining a plurality of tags that describe a plurality of content entities and determining a co-occurrence of the tags. The method and system further includes generating weighted vectors based on the determined co-occurrence of tags and characterizing the content entity based on the weight vectors. Thereby, the characterization of the content entity may be used for any number of suitable purposes, including, by way of example, improving search results and associated advertising relevancy.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to characterization of web content and more specifically to the characterization of web content based on the analysis of semantics of user generated content folksonomies associated with web content.

### BACKGROUND OF THE INVENTION

With the advent and growth of user generated content (UGC), there has been an on-going struggle to categorize this content and its associated information. Due to the inherent uncertainty of UGC, problems exist in understanding and effectively characterizing this information. For example, different users can use different terms for common items or use the same terms having different meanings, complicating characterization attempts. A more specific example may be a web location that allows users to upload and store photographs. Users can then generate content to describe the photo, these descriptions referred to in the current vernacular as tags. These user generated tags are then usable for a variety of purposes, including for example allowing other users to conduct searching operations, for example searching for photographs.

The current shortcomings of the UGC appear in many different facets of web activities associated with web content using UGC information. Searching operations are limited based on the accuracy of this information. Advertising is limited relative to the accuracy of the information and the effectiveness of search results. These shortcomings provide difficulties for selecting content-specific advertisements because of the inability to accurately determine the context of the search, search results and corresponding UGC.

With reference to web content, a folksonomy is a collection of user-defined labels for a public repository of objects. Examples of popular folksonomies include photo collection websites, bookmark sharing projects, video sharing websites, by way of example. Typically, users can add tags to any object they see, whether they own the object or not. Folksonomies facilitate interaction between web users and promote knowledge sharing by integrating user-defined tags in searching and browsing activities. In a sense, folksonomies comprises a competing approach to restricted lexicons, as numerous labels potentially allow users to achieve higher recall. When the original content creator might not have thought of all applicable tags, users who subsequently encounter the object are likely to add tags they deem relevant.

Some tags are automatically assigned, such as the example of a tag assigned to a photograph, the tag of the camera model and a geographic location. Although, the majority of tags are assigned manually by users. Based on the diversity of tagging content, the folksonomies encode a cornucopia of human knowledge which has not been properly harnessed for benefits associated with the corresponding content.

Regarding web based activities, the business of web search relies heavily on sponsored search, whereas a few carefully-selected paid textual ads are displayed alongside algorithmic search results. Identifying relevant ads is challenging because a typical search query is short and because users often choose terms to optimize web search results rather then advertisements.

Sponsored search is an interplay of three entities. The advertiser provides the supply of ads, as in traditional advertising, the goal of the advertisers is to promote product and services. The search engine provides a location for placing the ads by allocating space on the web results page and selects ads that are relevant to the user's query. Users visit the web pages of the publisher and interact with the ads.

There is a fine, but important, line between placing ads relevant to the query and placing unrelated ads. Users often find the former to be beneficial as an additional source of information or Web navigation, the latter may annoy the searchers and hurt the user experience. Search engines select ads based on their expected revenue, computed as a probability of a click times the advertiser's bid. Relevance relates directly to effectiveness of an advertisement, the more relevant the ad, the more likely a person is to click on the ad and thus generate effective advertising revenue, therefore the more relevant the ad, the more effective the understanding and more financially effective the advertising and placement of advertising becomes.

Accordingly, there exists a need for utilizing folksonomy techniques for improving web activity recognition, as well as directed web-based advertisement.

### SUMMARY OF THE INVENTION

The present invention is directed towards a method and system for characterizing web content based on capturing semantics of folksonomies relating to content entities of user generated content. The method and system includes determining a plurality of tags that describe a plurality of content entities and determining a co-occurrence of the tags. The method and system further includes generating weighted vectors based on the determined co-occurrence of tags and characterizing the content entity based on the weight vectors. Thereby, the characterization of the content entity may be used for any number of suitable purposes, including, by way of example, improving search results and associated advertising relevancy.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates one embodiment of a system for characterizing web content based on capturing semantics of folksonomies relating to content entities user generated content (UGC);

FIG. 2 illustrates a flowchart of a method for characterizing web content based on capturing semantics of folksonomies relating to content entities UGC;

FIGS. 3-5 illustrate sample screenshots of web pages having web content and content entity UGC related thereto; and

FIG. 6 illustrates a sample data matrix usable for generating weighted vectors based on co-occurrence of tags for characterizing the content entity as described herein.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and design changes may be made without departing from the scope of the present invention.

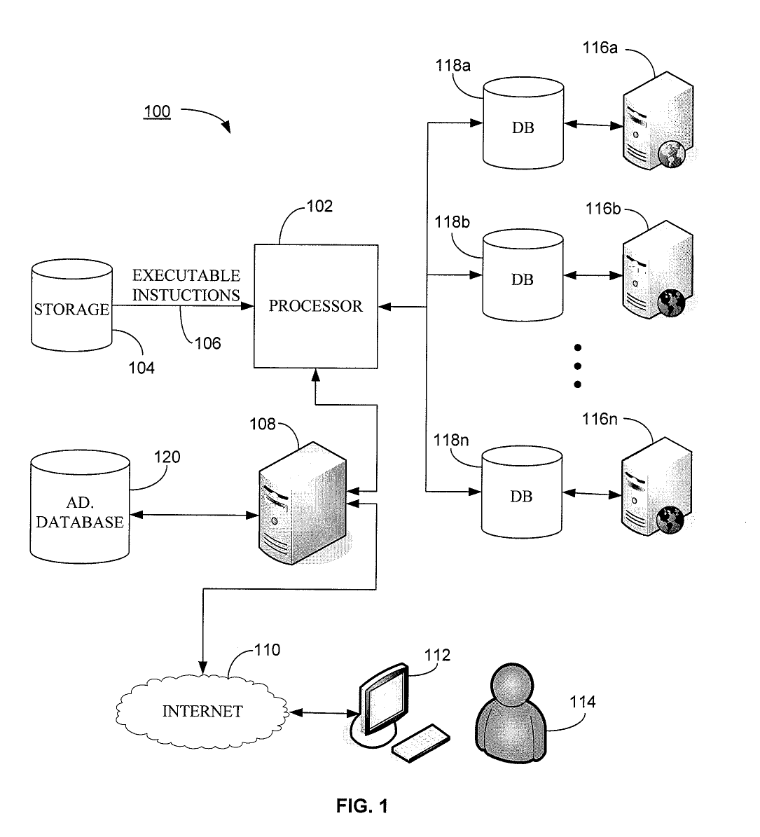

FIG. 1 illustrates a system 100 that includes a processor 102 and a storage device 104 having executable instructions 106 stored therein. The system 100 further includes a server computer 108, Internet 110, user computer 112 and user 114. The system 100 further includes a plurality of web servers 116a, 116b and 116n and associated databases 118a, 118b and 118n, where n is any suitable number. Moreover, the web servers are generally referred to by the reference number 116 and the associated databases are generally referred to by the reference number 118. In one embodiment, the system 100 further includes an advertising database 120.

The processor 102 may be any suitable type of processing device operative to perform processing operations in response to the executable instructions 106, wherein the executable instructions provide for processing operations as described in further detail herein. The storage device 104 may be any suitable type of storage device operative to store the executable instructions thereon such that upon transmission to the processor 102, the processor is operative to perform the processing operations.

The server computer 108 may be one or more server devices operative to perform server operations, including interfacing with the user 114 via the user's computer 112 across the Internet 110. This communication may utilize communication protocols and/or techniques consistent with knowledge of one skilled in the art. In one embodiment, the server computer 108 may be a plurality server processing devices managing internet connectivity between any number of users, such as a publicly available Internet search engine, where users access the web site for search request operations.

The web servers 116 and associated databases 118 represent various web locations capable of providing user access to and storage of user generated content thereon. Not specifically illustrated, for clarity purposes only, the web servers 116 may be accessibly by the user 114 via the Internet 110, such as typing in a URL in a web browser running on the user computer 112. Additionally, the processor 102 may also be in communication with the database 118 via a networked connection, e.g. the Internet 110, and does not require a direct connection as illustrated in FIG. 1. Various levels of communications may utilize existing and well known data transfer protocols, as recognized by one skilled in the art.

The advertising database 120 may include advertising information usable by the server 108 for inclusion with output displays. The advertising database 120 may be any number of data storage devices having advertising information thereon, as recognized by one skilled in the art. Additionally, the server 108 may include additional processing operations relating to the selection of particular ads and the placement of these ads in output displays, wherein the selection of a particular advertisement may be aided by the processing operations of the processor 102 in performing processing steps using information relating to UGC from the database 118.

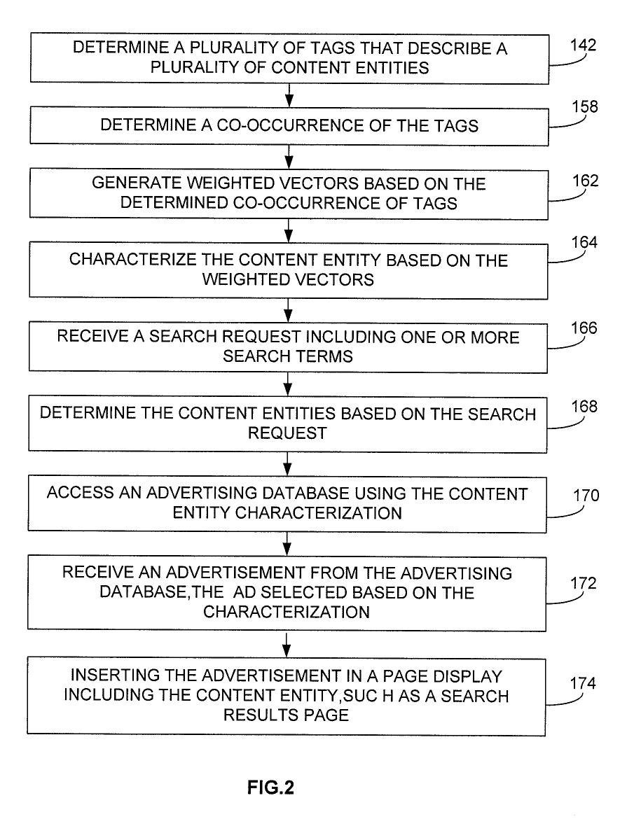

Various embodiments of operations of the system 100 are described in further detail relative to the flowchart of FIG. 2, wherein FIG. 2 illustrates different embodiments for a method for characterizing web content based on capturing semantics of folksonomies relating to content entities of UGC. In FIG. 2, a first step, step 140, is determining a plurality of tags that describe a plurality of content entities. With reference to FIG. 1, this step may be performed by the processing device 102 in response to executable instructions 106 from the storage device 104. The tags may be determined from the database 118 associated with the web server 116.

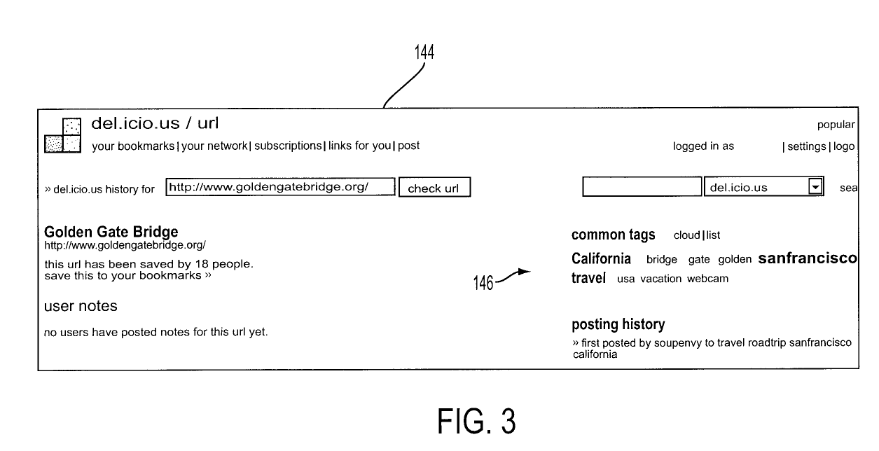

For further illustration, FIG. 3 illustrates a sample web location that includes UGC. FIG. 3 illustrates a screen shot 144 of an online web address or hyperlink storage web location. In this example, FIG. 3 illustrates a screen shot from the del.icio.us web site. This sample screenshot includes the content entity relating to a web bookmark, this example being the web address “http://www.goldengatebridge.org.” The del.icio.us entry is the user generated content as a user selectively generates this content and the content entity includes tags associated therewith, the tags describe the content entity. In this exemplary screenshot, the tags 146 include the terms: California, bridge, gate, golden, sanfrancisco, travel, usa, vacation, and webcam.

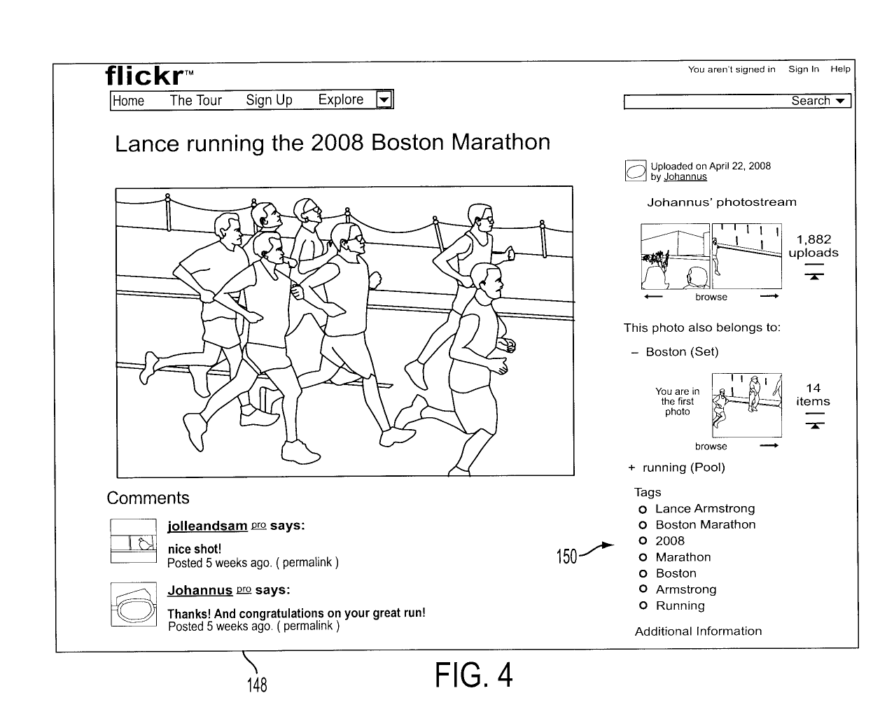

For further illustration, FIG. 4 illustrates another sample web location that includes UGC. FIG. 4 illustrates a screen shot 148 of an online photo storage and viewing location. In this example, FIG. 4 illustrates a screen shot from the Flickr™ web site. This sample screen shot includes a photograph of Lance Armstrong running the 2008 Boston Marathon, where the sample screen shot includes various amount of UGC. The content entity in this example is the photograph, which includes tags 150. In this example, the tags include: Lance Armstrong, Boston Marathon, 2008, Marathon, Boston, Armstrong, and Running.

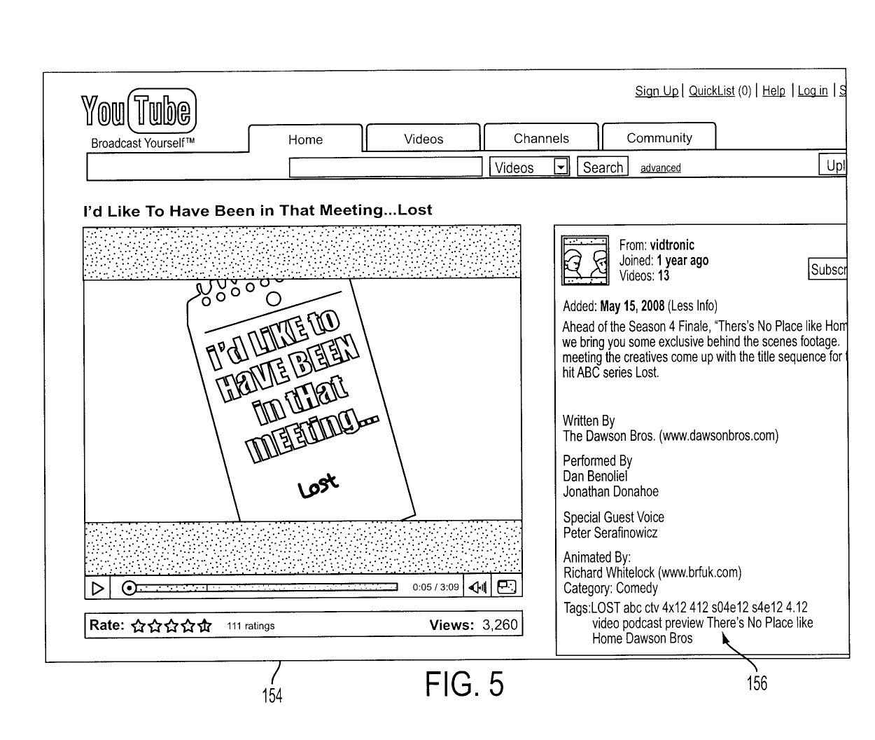

For additional illustrations, FIG. 5 illustrates another sample web location that includes UGC. FIG. 5 illustrates a screen shot 152 of an online video storage and viewing location. In this example, FIG. 5 illustrates a screen shot from the YouTube® web site. This sample screen shot includes a video, which is the content entity having tags associated therewith. The tags, similar to tags in screenshots in FIGS. 3-4, can be UGC, where in the screen shot 154, the tags 156 are: LOST, abc, ctv, 4x12, 412, s04e12, s4e12, 4.12, video, podcast, preview, There's, No, Place, Like, Home, Daswon, Bros.

With reference back to the method and flowchart of FIG. 2, the step 142 includes determining the tags, such as the tags 146, 150 and 156 of FIGS. 3-5 by way of example, for the content entities, as noted above. A next step, step 158, is to determine a co-occurrence of the tags.

The methodology provides for using folksonomies for site-specific query augmentation, including a preprocessing phase and a processing phase. In the preprocessing phase, the system analyzes a set of objects in a folksonomy F and builds a tag occurrence matrix M, where M(i,j) is the number of objects co-tagged with tags tᵢ and tⱼ. One technique ignores cells where M(i,j) equals 1.

An exemplary tag matrix is illustrated in the matrix 160 of FIG. 5. This matrix includes four sample tags: doll; hand; wool; and felted. The fields of the matrix are updated to indicate the number of co-occurrences of these tags. For example, there are 3 co-occurrences of the tags “doll” and “hand,” in other words there are three content entities that include both of these tags. The matrix may be further utilized as described in further detail below.

With reference back to FIG. 2, the next step of this methodology includes the step of, step 162, generating weighted vectors based on the determined co-occurrence of tags. This weighted vector, for example, may be in response to a user search or input query. In one embodiment, the next step, step 164, is to characterize the content entity based on the weighted vectors. With reference to FIG. 1 these steps may be performed by the processing device 102 using information from the database 118.

Processing the input query involves two main phases. The first phase is to tokenize the query into words and then map the words into relevant tags. For each tag tᵢ, the method looks up its co-occurrence vector, namely a row M(i), and finally sums the retrieved vectors to obtain a single context vector V for the query. The method may then decimate the vector entries by retaining only the n most frequently co-occurring tags (e.g. n=10 . . . 100). Since many tags include several words (e.g. sanfrancisco), the system can use a dynamic programming algorithm trained on the ad corpus to break tags into individual words, and update the counts in V accordingly. The values of individual vector entries are assigned using the TFIDF scheme with logarithmic term frequency and IDF computed over the ad corpus.

The methodology thereby uses the context vector to construct an augmented ad query, to be executed against a corpus of ads. Ad queries are represented with two kinds of features. The method uses feature selection to identify most salient words in V, and uses them to augment the bag of words representation of the query. The method also considers the context vector as a pseudo-document, and classifies it with respect to a large commercial taxonomy having a large number of nodes. A top most portion of the relevant class nodes, along with the ancestors, may comprise a second group of features. For example, this large commercial taxonomy may be a secondary source or a self-learning source of UGC, by way of example a web-based encyclopedia of UGC.

In the embodiment relating to advertising, the method may then analyze the ad text and construct the same two types of features as for queries, namely words and classes. In an online advertising system, the number of ads can easily reach hundreds of millions, hence the system may build an inverted index to facilitate fast ad retrieval. Finding relevant ads for the query amounts to evaluating the scores of candidate ads, and then retrieving the desired number of highest-scoring ads as linear combination of cosine similarity scores over the two feature sets.

Upon completion of step 164, one embodiment of the methodology may be complete, whereupon the content entity is then characterized based on the weighted vector. Additional embodiments may include further processing steps for additional operations relating to the utilization of the characterization of the content entity. For example, one embodiment may include associating relevant advertising to user activities based on the characterized content entity consistent with techniques described above. With reference to FIG. 1, this may include the server 108 in operative communication with the advertising database 120.

As illustrated in FIG. 2, step 166 is to receive a search request including one or more search terms. This search request may be received by the server 108 from the user 114 via the user computer 112 using existing search requesting techniques. For example, the searching may be via a search engine interface for a search-specific web site or in another example may be a search function associated with a UGC site, such a search function within one of the exemplary sites illustrated in the screen shots of FIGS. 3-5.

In response to the search request, the method includes determining the content entities based on the search request, step 168. This step may be performed using known searching techniques or other techniques recognizable to one skilled in the art. Upon determination of the content entities, the method may include accessing an advertising database using the content entity characterization, step 170. The content entity characterization may be performed prior to the searching operation or in another embodiment with existing processing overhead, the content entity characterization may be performed upon the completion of the determination step 168.

In response to access to the database using this content entity characterization, the method includes receiving an advertisement from the advertising database, the ad selection is based on the characterization, step 172. As noted above, with reference to FIG. 1, the server 108 may access the advertising database 120 and retrieve or cause the server 108 to receive particular advertisements. The selection of advertisements may be performed using known selection techniques, wherein the criteria used for the selection uses the content entity information now currently available based on the above-noted methodology.

Upon the receipt of the advertisement, a next step, step 174, is inserting the advertisement in a page display that includes the content entity. For example, a page display may be a search results page. In the example where a user is searching UGC, the search results can include content entities selected based, in part, on the weighted vectors as described above, as well as advertisement that have been selected to be more accurately relevant to the search results. In the above example, the UGC may include the content entities of a web link, a photograph and video, where each of these content entities include descriptive tags. Using this methodology, a user can effectively search the UGC, the accuracy of the search and associated advertisement information improves relevancy based on harnessing the existing UGC of tags.

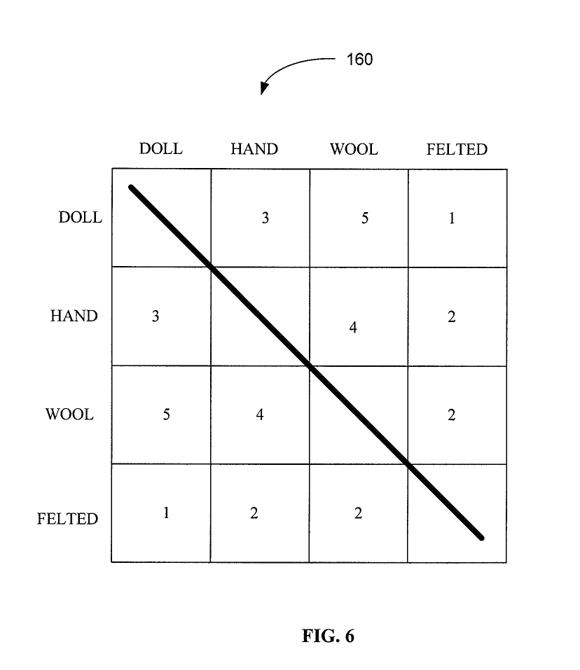

FIGS. 1 through 6 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

1. A method for characterizing web content based on capturing semantics of folksonomies relating to content entities of user generated content (UGC), the method comprising:
determining a plurality of tags that describe a plurality of the content entities;
determining a co-occurrence of the tags;
generating weighted vectors based on the determined co-occurrence of tags; and
characterizing the content entity based on the weighted vectors.

2. The method of claim 1 further comprising:
receiving a search request including at least one search term; and
determining the content entities based on the search request.

3. The method of claim 2 further comprising:
accessing an advertising database using the content entity characterization; and
receiving an advertisement from the advertising database, the advertisement selected based on the content entity characterization.

4. The method of claim 3 further comprising:
inserting the advertisement in a page display including the content entity.

5. The method of claim 4, wherein a page display includes a search results page.

6. The method of claim 1, wherein the determination of co-occurrence of tags includes:
generating a square matrix, each column including at least one of the tags and each row including the same at least one of the tags; and
incrementing a counter value for each of the matrix entries for each co-occurrence of tags.

7. The method of claim 6 further comprising:
generating the weighted vectors using the counter values for each of the matrix entries.

8. The method of claim 7, wherein the generation of the weighted vectors includes a TFIDF weighting scheme.

9. The method of claim 1, wherein the tags include more then one word.

10. The method of claim 1 further comprising:
accessing a self-learning resource in determining the co-occurrence of the tags.

11. A system for characterizing web content based on capturing semantics of folksonomies relating to content entities of user generated content (UGC), the system comprising:
a memory device having executable instructions stored therein; and
a processing device, in response to the executable instructions; operative to:
determine a plurality of tags that describe a plurality of the content entities;
determine a co-occurrence of the tags;
generate weighted vectors based on the determined co-occurrence of tags; and
characterize the content entity based on the weighted vectors.

12. The system of claim 11, the processing device, in response to further executable instructions, further operative to:
receive a search request including at least one search term; and
determine the content entities based on the search request.

13. The system of claim 12 further comprising:
an advertising database; and
the processing device further operative to:
access the advertising database using the content entity characterization; and
receive an advertisement from the advertising database, the advertisement selected based on the content entity characterization.

14. The system of claim 13, the processing device further operative to:
insert the advertisement in a page display including the content entity.

15. The system of claim 14, wherein a page display includes a search results page.

16. The system of claim 11, wherein the determination of co-occurrence of tags includes:
generating a square matrix, each column including at least one of the tags and each row including the same at least one of the tags; and
incrementing a counter value for each of the matrix entries for each co-occurrence of tags.

17. The system of claim 16, the processing device further operative to:
generate the weighted vectors using the counter values for each of the matrix entries.

18. The system of claim 17, wherein the generation of the weighted vectors includes a TFIDF weighting scheme.

19. The system of claim 11, wherein the tags include more then one word.

20. The system of claim 11 further comprising:
a self-learning resource in operative communication with the processing device; and
the processing device further operative to access the self-learning resource in determining the co-occurrence of the tags.
